(19) United States
(12) Patent Application Publication
(10) Pub. No.: US 2002/0053457 A1
(43) Pub. Date: May 9, 2002

(54) Insulation-displacement terminal fitting

(76) Inventors: Masahiko Aoyama, Yokkaichi-City (JP); Eiji Kojima, Yokkaichi-City (JP)

Correspondence Address: CASELLA & HESPOS, 274 MADISON AVENUE, NEW YORK, NY, 10016

(21) Appl. No.: 09/921,686

(22) Filed: Aug. 3, 2001

(30) Foreign Application Priority Data
Jul. 8, 2000 (JP) 2000-238900

(51) Int. Cl. H01B 17/16

(52) U.S. Cl. 174/84 C

(57) ABSTRACT

An insulation-displacement groove (24) is formed between blades (20) that project at right angles from opposed side walls (22). The insulation-displacement groove (24) includes a straight contact groove (26) directly below a guide groove (25). The guide groove (25) has an angled tapered shape defined by moderately sloped edges (31) at its upper side and steeply sloped edges (32) at its lower side. When a coated wire (W) is pushed in, cuts are made in a coating (Wb) by boundary portions (35) between the moderately sloped edges (31) and the steeply sloped edges (32). As the wire (W) is pushed further, a core (Wa) of the wire (W) is guided into the center of the contact groove (26) by the steeply sloped edges (32), consequently establishing a contact by being tightly held between contact edges (33).

### BACKGROUND OF THE INVENTION

1. Field of the Invention

The present invention relates to an insulation-displacement terminal fitting.

2. Description of the Related Art

A known insulation-displacement terminal fitting is shown in FIG. 8 and is formed to include left and right sidewalls 1. Blades 2 are formed by making cuts in the side walls 1 and bending cut portions toward one another at right angles to the sidewalls. An insulation-displacement groove 3 is formed between the blades 2 and includes a tapered guide groove 4 whose width is gradually narrowed toward its bottom end and a straight contact groove 5 below the tapered guide groove 4. A coated wire W is pushed toward the contact groove 5 from the guide groove 4, so that a coating Wb of the wire W is cut by a boundary portion 6 between the guide groove 4 and the contact groove 5. The exposed core Wa of the wire W is held tightly between contact edges 7 of the contact groove 5 and is connected to the blades 2. Insulation-displacement terminal fittings having such a construction are disclosed, for example, in Japanese Unexamined Utility Model Publication No.2-150764.

The guide groove 4 of the insulation-displacement groove 3 functions mainly to guide the coated wire W to the center of the contact groove 5. There are various discussions on the shape of the guide groove 4 including its angle of inclination.

For example, if the inclination of the guide groove 4 is moderate, the guiding function of guiding the coated wire W to the center of the contact groove 5 is poor. Thus, both the coating Wb and the core Wa may be cut due to an acute angle of the boundary portion 6 between the guide groove 4 and the contact groove 5. However, the moderate inclination has an advantage that the blades 2 are allowed to have a short height.

Conversely, if the inclination of the guide groove 4 is steep, the terminal fitting becomes larger due to a larger height of the blades 2. Additionally, the steep guide groove 4 complicates cutting the coating Wb even though the steep slope provides an excellent function of guiding the coated wire W to the center of the contact groove 5.

The present invention was developed in view of the above situation and an object thereof is to improve contact reliability while preventing a terminal fitting from becoming larger.

### SUMMARY OF THE INVENTION

The invention is directed to an insulation-displacement terminal fitting with an insulation-displacement groove. The insulation-displacement groove has at least one tapered guide groove and at least one contact groove. The tapered guide groove has a width that is gradually narrowed in an insertion or pushing direction of the coated wire into the insulation-displacement groove. More particularly, the guide groove has an angled, tapered or narrowed shape with a moderate inclination at a front side and a steep inclination at a back side with respect to the inserting direction of the coated wire into the insulation-displacement groove. The contact groove preferably is provided continuously at a back side of the tapered guide groove in the insertion direction, and is dimensioned to be brought into contact with a core of an insulated wire.

A coated wire can be pushed through the guide groove and toward the contact groove. Thus, boundary portions between the moderately sloped edges and the steeply sloped edges of the guide groove cut the coating. Additionally, the exposed core is guided toward the center of the contact groove by the steeply sloped edges. Consequently, the core is held tightly between the contact edges.

The moderately sloped edges at the front side of the guide groove and the steeply sloped edges at the back side with respect to the pushing direction enables the entire insulation-displacement groove to have a reduced depth. Thus, the terminal fitting is prevented from becoming larger, the coating can be cut satisfactorily and the core can be guided precisely to the center of the contact groove. Therefore, contact reliability can be remarkably improved.

The insulation-displacement groove preferably is formed between blades that project from left and right side walls of the insulation-displacement terminal fitting to substantially face each other.

The insulation-displacement groove may be formed in a portion of a bottom wall of the insulation-displacement terminal fitting, and may be bent at an angle different than 0° or 180°, preferably substantially normal to the bottom wall.

Preferably, the insulation-displacement groove is formed between a pair of blades that project inwardly substantially in V-shape when viewed in the inserting direction of the coated wire.

The present invention is applicable to insulation-displacement terminal fittings of the type in which the coating is cut open by getting caught by V-shaped blades. Specifically, a portion for cutting the coating open has a large area in the V-shaped blades. Consequently, an attempt to forcibly cut the coating open may cause the coating to be torn over a wide area. As a result, the core may be exposed after connection by insulation displacement and a contact failure may occur due to a loosening of the core. However, in the present invention, the coating can be cut open more easily by the boundary portions between the moderately sloped edges and the steeply sloped edges of the guide groove. Thus, a cut-open portion of the coating is kept to a minimum size, thereby preventing the exposed portion of the core from becoming larger.

Preferably, a first angle formed between the moderate inclination portion and a line normal to the wire insertion direction is about 45° or larger and a second angle formed between the steep inclination portion and this line is between the first angle and 90°.

Further preferably, a spacing A between boundary portions between the moderate and steep inclination portions of the guide groove, a diameter B of a core of the coated wire and a width C of the insulation-displacement groove satisfy a relationship A≧B≧C.

A height of the moderate inclination portion along the insertion direction preferably is at least half the height of the guide groove.

Two insulation displacement grooves may be provided in longitudinally spaced positions, and one or more coupling portions may couple distal portions of the blades.

The contact groove and the tapered guide groove preferably are defined between blades that are formed by making cuts in side walls and bending the cut portions by an angle different from 0° or 180°, preferably by substantially 90° with respect to the side walls.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a perspective view partly cut away showing a first embodiment of the present invention.

FIG. 2 is a section along 2-2 of FIG. 1.

FIG. 3 is a section along 2-2 of FIG. 1 when connection by insulation displacement is completed.

FIG. 4 is a perspective view o f a second embodiment.

FIG. 5 is a perspective view of a third embodiment.

FIG. 6 is a plan view of a fourth embodiment.

FIG. 7 is a lateral section of the fourth embodiment.

FIG. 8 is a lateral section of a prior art.

### DETAILED DESCRIPTION OF THE PREFERRED EMBODIMENTS

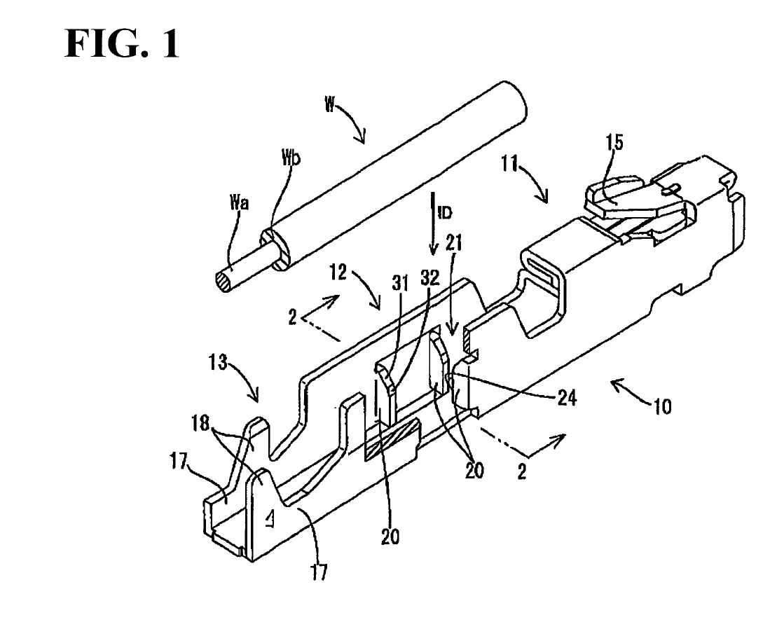

An insulation-displacement terminal fitting in accordance with a first embodiment of the invention is identified by the numeral 10 in FIGS. 1 to 3. The terminal fitting 10 is used with a known coated wire W that has a core Wa made, for example, by twisting strands. The core Wa is covered with a coating Wb made, for example, of a synthetic resin. The terminal fitting 10 of this embodiment is formed into a shape shown in FIG. 1 by successively cutting and bending a metallic plate with a press. The formation is carried out to define a terminal fitting 10 with a connecting portion 11, an insulation-displacement portion 12 and a barrel 13 in this order from its leading end, which is the end that is to be connected with an unillustrated mating connector.

The connecting portion 11 is substantially in the form of a rectangular tube that is hollow in forward and backward or longitudinal directions. A metal locking portion 15 is formed at the lateral or upper wall of the connecting portion 11 by cutting and bending and/or embossing. An elastic contact piece (not shown) is provided inside the connecting portion 11 by folding back a tongue that extends from the front end of the bottom wall. A tab of an unillustrated male terminal fitting can be inserted into the connecting portion 11 from the front for elastic or resilient contact with the elastic contact piece.

The barrel 13 is at the rear end of the terminal fitting 10, and has two longitudinally offset crimping pieces 18 that project respectively from left and right short side walls 17. The coated wire W can be fastened to the insulation-displacement terminal fitting 10 by crimping, bending or folding the crimping pieces 18 into connection with the coated wire W.

The insulation-displacement portion 12 is in the form of a channel or groove having an open upper surface, and two longitudinally spaced blade portions 21. Each blade portion 21 is comprised of left and right blades 20 that are formed by making cuts in the left and right side walls 22 and bending the cut portions substantially at right angles so as to substantially oppose to each other at a specified spacing. Thus, an insulation-displacement groove 24 is formed between the facing edges of the opposed blades 20.

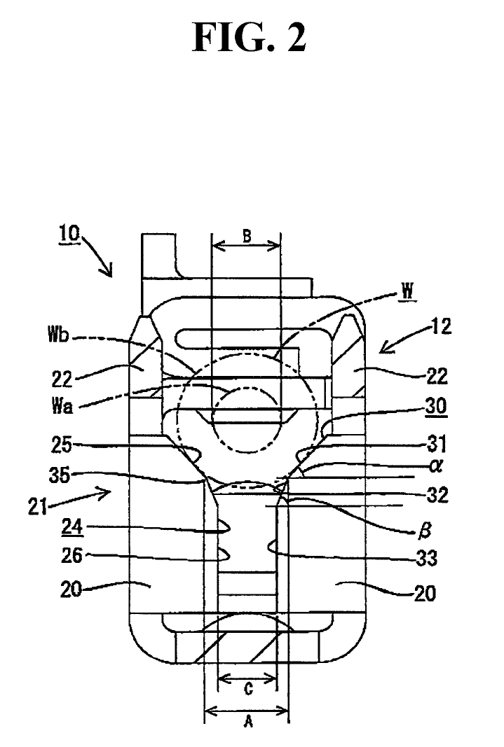

As shown in FIG. 2, an upper part of the facing edge of each blade 20 defines a slanted edge 30 that gradually projects inwardly as it extends toward its bottom end. The slanted edge 30 is comprised of a moderately slanted edge 31 at its upper part and a steeply slanted edge 32 at its lower part. The steeply slanted edge 32 has an inclination that is steeper than the moderately slanted edge 31. The remainder of each facing edge on each blade 20 defines a contact edge 33 that preferably is substantially straight in a vertical direction or arranged at about 90° with respect to the bottom edge of the insulation-displacement groove 24.

In other words, the insulation-displacement groove 24 is formed to define a guide groove 25 with an angled tapered shape defined by the moderately sloped edges 31 at its upper side and the steeply sloped edges 32 at its lower side. A substantially straight contact groove 26 is provided below and adjacent the guide groove 25 The terminal fitting 10 is configured to satisfy a relationship A≧B≧C, where A is a spacing between left and right boundary portions 35 between the moderately and steeply slanted edges 31, 32 of the guide groove 25, B is a diameter of the core Wa of the coated wire W and C is a width of the insulation-displacement groove 24.

Further, it is desirable that an angle a formed between the moderately slanted edges 31 and a horizontal line normal to a wire pushing direction is 45° or larger and an angle β formed between the steeply slanted edges 32 and this horizontal line is between α and 90°.

An end portion of the coated wire W can be pushed into the insulation-displacement portion 12 along an insertion direction ID as shown by an arrow in FIG. 1. More particularly, the coated wire W initially is placed on the guide grooves 25 of the insulation-displacement grooves 24 of the front and rear blade portions 21 as indicated by phantom line of FIG. 2. The coated wire W then is pushed between the front and rear blade portions 21 and at the front and rear sides of the front and rear blade portions 21 by an unillustrated pressing jig.

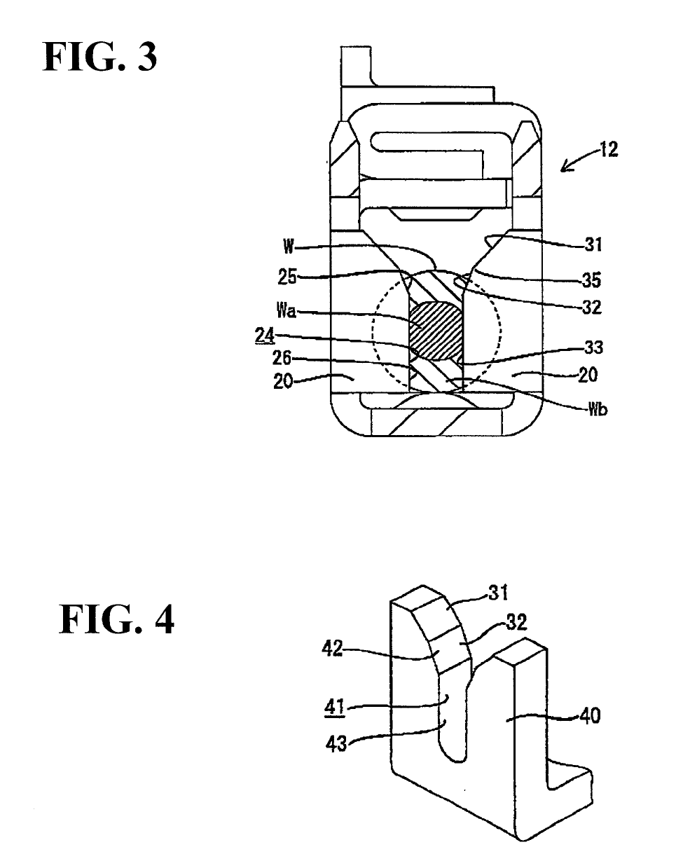

Pushing forces on the coated wire W cause the boundary portions 35 between the moderately sloped edges 31 and the steeply sloped edges 32 of the guide grooves 25 to make cuts in the coating Wb. Additionally, the core Wa of the coated wire W is guided substantially toward the center of the contact groove 26 by the steeply sloped edges 32 of the guide grooves 25. Further pushing causes the coating Wb to be cut sufficiently to expose part of the core Wa and the exposed part of the core Wa is pushed into the contact groove 26 as shown in FIG. 3. Consequently, the core Wa is held tightly between the contact edges 33 and establishes contact.

The barrel 13 is crimped into connection with the coated wire W at a position behind the portion of the coated wire W connected by insulation displacement and at a side of the terminal fitting 10 opposed to the connecting portion 11. The crimping of the barrel 13 may be carried out as the coated wire W is connected by insulation displacement.

Several advantages can be provided by forming the guide groove 25 of the insulation-displacement groove 24 with an angled tapered shape defined by the moderately sloped edges 31 at its upper side and the steeply sloped edges 32 at its lower side.

For example, the coating Wb can be cut satisfactorily by suitably sharpening the boundary portions 35 between the moderately sloped edges 31 and the steeply sloped edges 32 of the guide groove 25. The steeply sloped edges 32 are formed at the back side of the guide groove 25 with respect to the wire pushing direction. Thus, the exposed core Wa can be guided precisely inwardly, substantially to the center of the contact groove 24. Additionally, the core Wa is not cut since an angle between the steeply sloped edges 32 and the contact edges 33 is a relatively large obtuse angle (β+90°). As a result, contact reliability can be improved remarkably.

Further, by forming the moderately sloped edges 31 over more than half the dimension of the guide groove 25 with respect to height direction, the entire depth of the insulation-displacement groove 24, i.e. the height of the blades 20, can be suppressed to a small value, thereby preventing the insulation-displacement terminal fitting 10 from becoming larger.

FIG. 4 shows a second embodiment of the present invention. In the second embodiment, a unitary blade portion 40 with an insulation-displacement groove 41 is formed by making a cut in the bottom plate and bending a cut portion substantially normal to the bottom plate. Specifically, the insulation-displacement groove 41 is formed with a guide groove 42 and a substantially straight and bottomed contact groove 43 below the guide groove 42. The guide groove 42 has an angled tapered shape defined by moderately sloped edges 31 at its upper side and steeply sloped edges 32 at its lower side similar to those of the first embodiment. The same function and effects as the first embodiment can be obtained in the second embodiment.

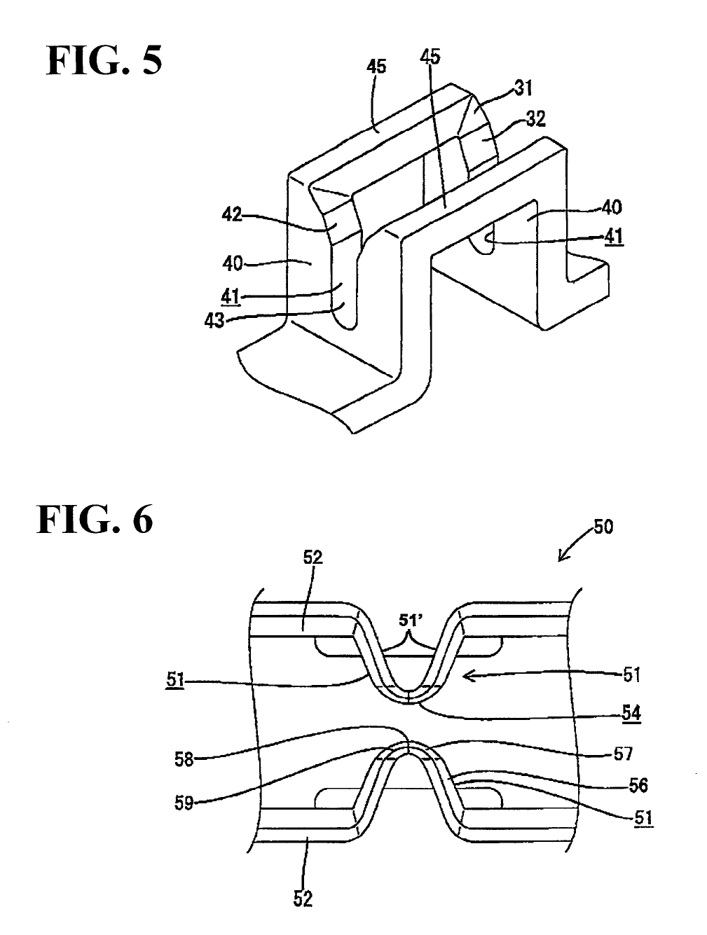

FIG. 5 shows a third embodiment of the present invention with blades 40 formed with insulation-displacement grooves 41. Upper or distal ends of the front and rear blade portions 40 are coupled by coupling or bridging portions 45 to prevent the blade portions 40 from being inclined during connection by insulation displacement.

In the third embodiment, the insulation-displacement groove 41 of each blade portion 40 is formed with a guide groove 42 and a straight and bottomed contact groove 43 below the guide groove 42. The guide groove 42 has an angled tapered shape defined by moderately sloped edges 31 at its upper side and steeply sloped edges 32 at its lower side. The same function and effects as the first embodiment can also be obtained in the third embodiment.

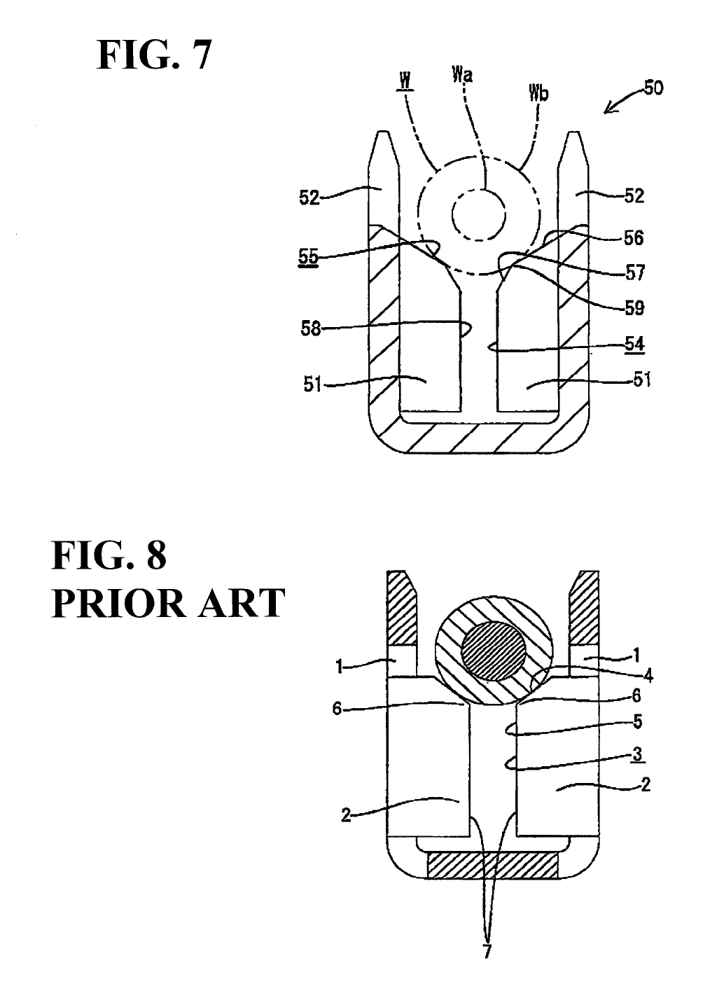

FIGS. 6 and 7 show a fourth embodiment with an insulation-displacement terminal fitting that has V-shaped blades. Specifically, left and right blade portions 51 are formed by embossing left and right or lateral side walls 52 to substantially face each other at a specified spacing, and an insulation-displacement groove 54 is defined between facing edges of the blades 51.

The insulation-displacement groove 54 has a guide groove 55 and a substantially straight contact groove 58 having a width smaller than a diameter of a core Wa of a coated wire W is provided below the guide groove 55. The guide groove 55 has an angled tapered shape by being defined by moderately sloped edges 56 at its upper side and steeply sloped edges 57 at its lower side.

When the coated wire W is pushed, cuts are made in a coating Wb by boundary portions 59 between the moderately sloped edges 56 and the steeply sloped edges 57 of the guide groove 55. The core Wa is exposed while the coating Wb is being turned up, cut or torn. The core Wa is then guided substantially toward the center of the contact groove 58 by the steeply sloped edges 56, pushed therein and tightly held between contact edges to establish a contact.

A portion for cutting the coating open has a large area in the V-shaped blade portions. Thus, if an attempt is made to forcibly cut the coating open, the coating may be torn over a wide area to expose the core after connection by insulation displacement and a contact failure may occur due to loosening of the core. However, the coating Wb can be cut open more easily by the boundary portions 59 between the moderately sloped edges 56 and the steeply sloped edges 57 of the guide groove 55 in this embodiment. Therefore, a cut-open portion of the coating Wb is kept to a minimum size, thereby preventing the exposed portion of the core Wa from becoming larger. Each blade portion 51 may be formed by providing two portions 51′ projecting inwardly from the side walls 52 (e.g. by cutting and bending and/or embossing), wherein distal ends thereof are contacted to form an overall embossed shape (see FIG. 6).

The fourth embodiment can improve contact reliability while preventing the insulation-displacement terminal fitting from becoming larger.

The present invention is not limited to the above described and illustrated embodiments, and various changes can be made without departing from the scope and spirit of the present invention as defined in the claims.

What is claimed is:

1. An insulation-displacement terminal fitting (10; 50), comprising an insulation-displacement groove (24; 41; 54) having at least one contact groove (26; 43; 58) for contact with a core (Wa) of an insulated wire (W) and at least one tapered guide groove (25; 42; 55) with a width that is gradually narrowed in an insertion direction (ID) of the coated wire (W) into the insulation-displacement groove (24; 41; 54), wherein the guide groove (25; 42; 55) has an angled tapered shape with a moderate inclination portion (31; 56) at a front side and a steep inclination portion (32; 57) at a back side with respect to the inserting direction (ID) of the coated wire (W) into the insulation-displacement groove (24; 41; 54).

2. An insulation-displacement terminal fitting according to claim 1, wherein the contact groove (26; 43; 58) is adjacent the tapered guide groove (25; 42; 55).

3. An insulation-displacement terminal fitting according to claim 1, wherein the insulation-displacement groove (24; 54) is formed between a pair of blades (21; 51) projecting from left and right side walls (22; 52) of the insulation-displacement terminal fitting (10; 50) to substantially face each other.

4. An insulation-displacement terminal fitting according to claim 1, wherein the insulation-displacement groove (41) is formed in a portion of a bottom wall of the insulation-displacement terminal fitting bent substantially normal to the bottom wall.

5. An insulation-displacement terminal fitting according to claim 1, wherein the insulation-displacement groove (54) is formed between a pair of blade portions (51) projecting inwardly substantially in V-shape when viewed in the insertion direction (ID) of the coated wire (W).

6. An insulation-displacement terminal fitting according to claim 1, wherein cuts are made in a coating (Wb) of the coated wire (W) by boundary portions (35; 59) between the moderate inclination portions (31; 56) and the steep inclination portions (32; 57) of the guide groove (25; 42; 55), when the coated wire (W) is at least partly inserted into the insulation-displacement groove (24; 41; 54).

7. An insulation-displacement terminal fitting according to claim 1, wherein a first angle (α) formed between the moderate inclination portion (31; 56) and a line normal to the wire insertion direction (ID) is at least about 45° and a second angle (β) formed between the steep inclination portion (32; 57) and the line normal to the wire insertion direction (ID) is between the first angle (α) and 90°.

8. An insulation-displacement terminal fitting according to claim 1, wherein a spacing A between boundary portions (35; 59) between the moderate and steep inclination portions (31, 32; 56, 57) of the guide groove (25; 42; 55), a diameter B of a core (Wa) of the coated wire (W) and a width C of the insulation-displacement groove (24; 41; 54) satisfy a relationship A≧B≧C.

9. An insulation-displacement terminal fitting according to claim 1, wherein a height of the moderate inclination portion (31; 56) along the insertion direction (ID) is at least half the height of the guide groove (25; 56).

10. An insulation-displacement terminal fitting according to claim 1, wherein two insulation displacement grooves (41) are provided in longitudinally spaced positions, respective distal portions of blade portions (40) thereof being coupled by one or more coupling portions (45).

11. An insulation-displacement terminal fitting according to claim 1, wherein the contact groove (26) and the tapered guide groove (25) are defined between a pair of blades (20) formed by making cuts in side walls (22) and bending the cut portions by substantially 90° with respect to the side walls (22).

12. An insulation-displacement terminal fitting (10; 50) for use with a coated wire (W) having a core (Wa) with a diameter (B), comprising first and second opposed spaced-apart blades (21; 51) having opposed substantially parallel contact edges (33) spaced apart by a selected distance (C) less than the diameter (B) of the core (Wa) to define a contact groove (26; 43; 58), each said blade (21; 51) further having a steeply inclined edge (32; 57) adjacent the respective contact edge (33) and aligned at a first obtuse angle to the respective contact edge (33) and a moderately inclined edge (31; 56) adjacent the steeply inclined edge (32; 57) and aligned to the respective contact edge (33) at a second obtuse angle, the second obtuse angle being less than the first obtuse angle, each said steeply inclined edge (32; 57) meeting the moderately inclined edge (31; 57) at a boundary (35), the boundaries (35) of the respective blades (33) being spaced apart by a distance (A) that is greater than the diameter (B) of the core (Wa).

13. The insulation-displacement terminal fitting (10; 50) of claim 12, further comprising first and second opposed side walls, the first and second blades (33) being unitary with the respective first and second side walls.

14. The insulation-displacement terminal fitting (10; 50) of claim 13, wherein said blades (33) are substantially planar and lie in a common plane.

15. The insulation-displacement terminal fitting (10; 50) of claim 13, wherein said blades (51) are substantially V-shaped.

16. The insulation-displacement terminal fitting (10; 50) of claim 12, further comprising a bottom wall, the blades (40) extending unitarily and substantially normally from the bottom wall,

17. An insulation-displacement terminal fitting (10; 50) unitarily formed from a metal material and comprising: a bottom wall, first and second opposed side walls extending from the bottom walls, first and second opposed spaced-apart blades (21; 51) aligned substantially normal to the bottom wall and between the side walls, said blades (21; 51) having opposed substantially parallel contact edges (33) spaced apart by a selected distance to define a contact groove (26; 43; 58), each said blade (21; 51) further having a steeply inclined edge (32; 57) adjacent the respective contact edge (33) and aligned at a first obtuse angle to the respective contact edge (33) and a moderately inclined edge (31; 56) adjacent the steeply inclined edge (32; 57) and aligned to the respective contact edge (33) at a second obtuse angle, the second obtuse angle being less than the first obtuse angle.

18. The insulation-displacement terminal fitting (10; 50) of claim 17, wherein the first and second blades (21; 51) define a first pair of blades (21), and wherein the insulation-displacement terminal fitting (10; 50) further defines a second pair of blades (21) spaced from the first pair of blades (21).

19. The insulation-displacement terminal fitting (10; 50) of claim 18, wherein the blades (21) in each said pair are substantially coplanar.

20. The insulation-displacement terminal fitting (10; 50) of claim 17, wherein the first and second blades are unitary with the respective first and second side walls.
